(19) United States
(12) Patent Application Publication
(10) Pub. No.: US 2012/0042157 A1
(43) Pub. Date: Feb. 16, 2012

(54) RAM Based Security Element for Embedded Applications

(75) Inventor: Maxime Leclercq, Encinitas, CA (US)

(73) Assignee: MaxLinear, Inc., Carlsbad, CA (US)

(21) Appl. No.: 13/026,000

(22) Filed: Feb. 11, 2011

Related U.S. Application Data
(60) Provisional application No. 61/303,506, filed on Feb. 11, 2010.

(51) Int. Cl. G06F 12/14; G06F 15/177

(52) U.S. Cl. 713/2; 713/193

(57) ABSTRACT

An integrated circuit includes a demodulator for receiving an encrypted message and a hardware unit coupled to the demodulator and configured to enable the demodulator to decrypt the received message. The hardware unit includes a processing unit, a read-only access memory (ROM) having a boot code causing the integrated circuit to fetch data from an external memory, a random access memory (RAM) for storing the fetched data, multiple non-volatile memory registers or fuses, and an interface unit configured to write the data stored in the RAM to an external storage in response to a backup event. The data may be encrypted using an encryption key prior to being written to the external storage. The interface unit may include a direct memory access controller. The external memory and the external storage can be a same non-volatile memory, namely a Flash device.

### CROSS-REFERENCES TO RELATED APPLICATIONS

The present application claims benefit under 35 USC 119(e) of U.S. provisional application No. 61/303,506, filed Feb. 11, 2010, entitled “RAM Based Security Element for Embedded Applications,” the content of which is incorporated herein by reference in its entirety. The present invention is related to U.S. application Ser. No. 61/301,948, filed Feb. 5, 2010, entitled “Conditional Access Integration in a SOC for Mobile TV Applications,” the content of which is incorporated herein by reference in its entirety.

### BACKGROUND OF THE INVENTION

Embodiments of the present invention relate to information processing. More particularly, embodiments of the present invention relate to a device and method having a RAM based security element and back-up mechanisms for providing data stored in the RAM to an external non-volatile storage or memory. A specific embodiment of the present invention may apply to conditional access systems for digital broadcast television.

There are several well-known digital radio and digital TV broadcast standards. In Europe, the digital radio broadcast is the DAB (Digital Audio Broadcasting) adopted by the ITU-R standardization body and by ETSI. The digital TV standard is DVB (Digital Video Broadcasting) in Europe, ATSC (Advanced Television Systems Committee) in the U.S., and ISDB (Integrated Services Digital Broadcasting) in Japan and South America. In addition to these standards, there are also mobile TV standards which relate to the reception of TV on handheld devices such as mobile phones or the like. Some well-known mobile TV standards are DVB-H (Digital Video Broadcasting-Handheld), CMMB (China), DMB (Digital Multimedia Broadcasting), and Mediaflo.

In most digital TV broadcasting services, the service providers scramble and encrypt the transmitted data streams to protect the broadcasted content and require their customers or users to install “security protection” mechanisms to decrypt and descramble the content. Security protection mechanisms such as digital rights management enable users to store content. Conditional access systems are other security protection mechanisms that allow users to access and view content but may or may not record the viewed content.

In a typical pay-TV system, the conditional access software runs on a dedicated secure element implementing robust mechanisms so as to prevent a malicious entity (“hacker”) from gaining access to the broadcast system secret to decipher the TV content. The CA instruction code and keys provisioned by the CA provider adapted to ensure security are typically stored in a non-volatile memory, such as an EEPROM or Flash, which are relatively expensive and require a specifically tuned CMOS process and additional process steps for fabrication.

FIG. 1 is a block diagram of a conventional TV receiver 100 performing conditional access (CA) functions. Receiver 100 includes a TV demodulator 110 coupled to a suitable antenna 105 for receiving broadcast content. Demodulator 110 is connected to a secure element 120. The connection can be a proprietary interface or a standard interface. Secure element 120 may be provided by the service provider and controls access to a broadcast service by descrambling a transmitted broadcast. Secure element 120 may also hold service entitlement information controlled by the service provider. The service provider may communicate with the secure element using encrypted messages that carry descrambling keys and other service management information. Secure element 120 descrambles encrypted data streams received from the TV demodulator and provides the descrambled data streams to a video and audio decoder 130. A display 140 coupled to the video and audio decoder displays the decoded video and audio data streams. In general, secure element 120 may be provided in several forms and in multiple packaging options. For example, the secure element may be a dedicated surface mount device mounted on the receiver, a SIM card, a secure SD card, or a module. The secure element typically includes a crypto processor, a secure CPU, read-only memory (ROM), and electrical erasable and programmable ROM (EEPROM) or Flash, as shown in FIG. 1.

FIG. 2 is a block diagram of a conventional secure element 200 showing components incorporated in the secure element 120 of FIG. 1. Secure element 200 includes a demodulator interface 210 that establishes a physical and electrical connection with the demodulator 110. Typically, the physical and electrical connection is a proprietary hardware interface that enables a user to plug the secure element to the TV demodulator. Secure element 200 also includes a secure CPU 220 that is configured to decrypt messages or data streams that are transmitted by the service providers. Secure element 200 further includes a plurality of hardware accelerators 230-1, 230-2, . . . , 230-n that assist the secure CPU for descrambling data streams and decode specific messages from the service provider. Secure element 200 additionally includes read-only memory 240 (ROM) and EEPROM/Flash 250. The ROM and EEPROM/Flash memory are programmed by the conditional access (CA) provider and contain CA firmware and decryption keys. When enabled by the user, CPU 220 executes program code stored in ROM and EEPROM/Flash memory and starts processing data streams received through the demodulator interface 210.

As shown in FIG. 1, the secure element 120 may include two physical interfaces, one for receiving encrypted data streams and the other one for sending decrypted data streams back to the demodulator. Other physical interfaces may exist for facilitating communication between the secure element and the demodulator.

It can be seen that the conventional secure element has a hardware architecture that is inflexible and adds costs to service providers. Furthermore, conventional techniques do not appear to address the concerns of service providers, CA operators, and content owners, specifically, at the point where content leaves the secure element.

### BRIEF SUMMARY OF THE INVENTION

Embodiments of the present invention provide an integrated circuit that integrates functions required to achieve security (secure element) in a monolithic silicon device formed on the same substrate using a conventional CMOS process, e.g., a CMOS system-on-a-chip (SOC). In an embodiment, the integrated circuit includes a demodulator for receiving an encrypted message and a hardware unit that is communicative coupled to the demodulator and configured to enable the demodulator to decrypt the received message. The hardware unit includes a processing unit, a read-only access memory (ROM) having a boot code configured to cause the integrated circuit to fetch data from an external memory, a random access memory (RAM) for storing the fetched data, multiple non-volatile memory registers or fuses, and an interface unit configured to write the data stored in the RAM to an external storage in response to a backup event. In an embodiment, the external memory and the external storage are a non-volatile memory. In an embodiment, the external memory and storage are a same Flash memory. In an embodiment, the interface unit comprises a direct memory access controller circuit. In an embodiment, the hardware unit encrypts the data stored in the random access memory using an encryption key prior to writing the encrypted data to the external storage. In an embodiment, the encryption key is generated using a unique code stored in one or more of the non-volatile memory registers or fuses and a seed number. In an embodiment, the seed number is a random number generated using a random number generator disposed in the hardware unit. In an embodiment, the encryption key is dynamically generated. In an embodiment, the backup event occurs in timed intervals or is triggered by a power-off condition. In an embodiment, the integrated circuit is a monolithic silicon device fabricated using conventional and widely available CMOS processes without additional process steps required for making EEPROM or Flash memory.

Embodiments of the present invention also disclose a data processing device having a random access memory (RAM) based security element for use in a conditional access system. The device includes a demodulator coupled to the RAM based security element for receiving encrypted information. The device performs the steps of receiving data from a first external memory, storing the received data in the RAM disposed in the security element, and determining whether a backup condition occurs. In the event that a backup condition occurs, the device encrypts the data stored in the RAM and writes the encrypted data to a second external memory. In an embodiment, the first and second external are a same Flash memory. In an embodiment, the data stored in the RAM is encrypted using an encryption key that is generated using a unique code stored in a non-volatile memory register disposed in the security element and a seed. In an embodiment, the seed is a random number generated by a random number generator disposed in the security element. In an embodiment, the encryption key is dynamically generated. In an embodiment, the backup condition is user driven or triggered by a power-down event. In an embodiment, the encrypted data is written to the second external memory using a direct memory access controller. In an embodiment, the received data may include a certificate and may be authenticate by the device. In an embodiment, the seed is written together with the encrypted data to the second external memory when a backup condition occurs.

A specific embodiment of the present invention discloses a device having a random access memory based security element for storing a computer program, wherein the computer program enables the device to process and decrypt digital television signals. The computer program causes the device to perform steps including encrypting the computer program stored in the random access memory and writing the encrypted computer program to an external non-volatile memory in response to a backup event. In an embodiment, the backup event can be user driven or triggered by a power-off condition. In an embodiment, the writing to the external memory includes a direct memory access controller.

### BRIEF DESCRIPTION OF THE DRAWINGS

FIG. 1 is a block diagram of a conventional TV receiver 100 performing conditional access (CA) functions;

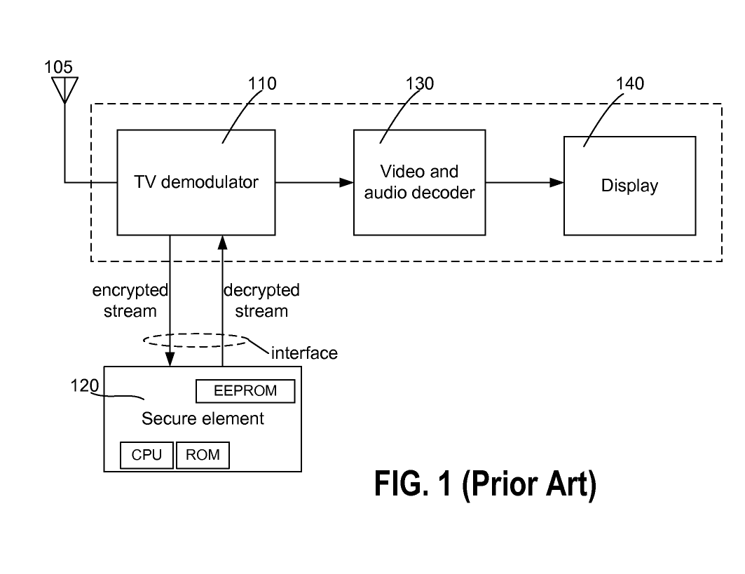

FIG. 2 is a block diagram of a conventional secure element 200 used in pay-TV applications;

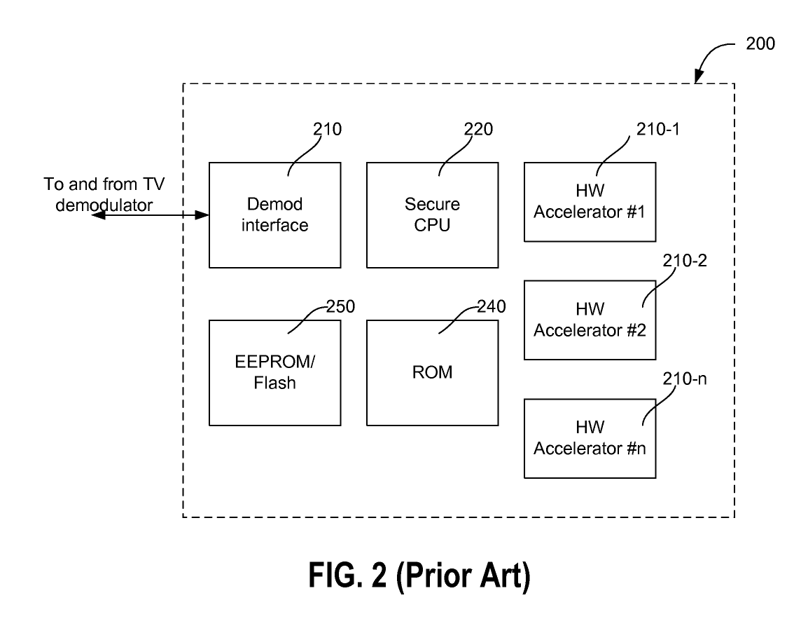

FIG. 3 is a simplified block diagram of an integrated conditional access sub-system in an SOC according to an embodiment of the present invention;

FIG. 4 is a simplified block diagram of an integrated secure element disposed in a demodulator SOC according to an embodiment of the present invention;

FIG. 5 is a simplified block diagram of an integrated secure element disposed in a demodulator SOC according to another embodiment of the present invention;

FIG. 6 is an exemplary process for generating an encryption key according to an embodiment of the present invention;

FIG. 7 is a flowchart diagram illustrating a data backup operation according to an embodiment of the present invention;

FIG. 8 is a simplified block diagram of a demodulator SOC illustrating an exemplary data backup operation according to an embodiment of the present invention; and

FIG. 9 is a simplified timing diagram illustrating a startup operation of a demodulator SOC according to an embodiment of the present invention.

### DETAILED DESCRIPTION OF THE INVENTION

Conditional access is used by TV broadcasters to generate revenue. To achieve this, security guidelines are used to protect the keys provisioned to the user and to guarantee that no hacker or malicious entity can crack the system and watch contents for free. These guidelines, also referred to as security requirements, define methods adapted to prevent misuse of the SOC (system-on-chip) device and its associated firmware, and furthermore to inhibit unauthorized access to secrets, such as keys, operating modes, etc. The SOC security framework described herein defines hardware (HW), software (SW), or a combination thereof to achieve these objectives.

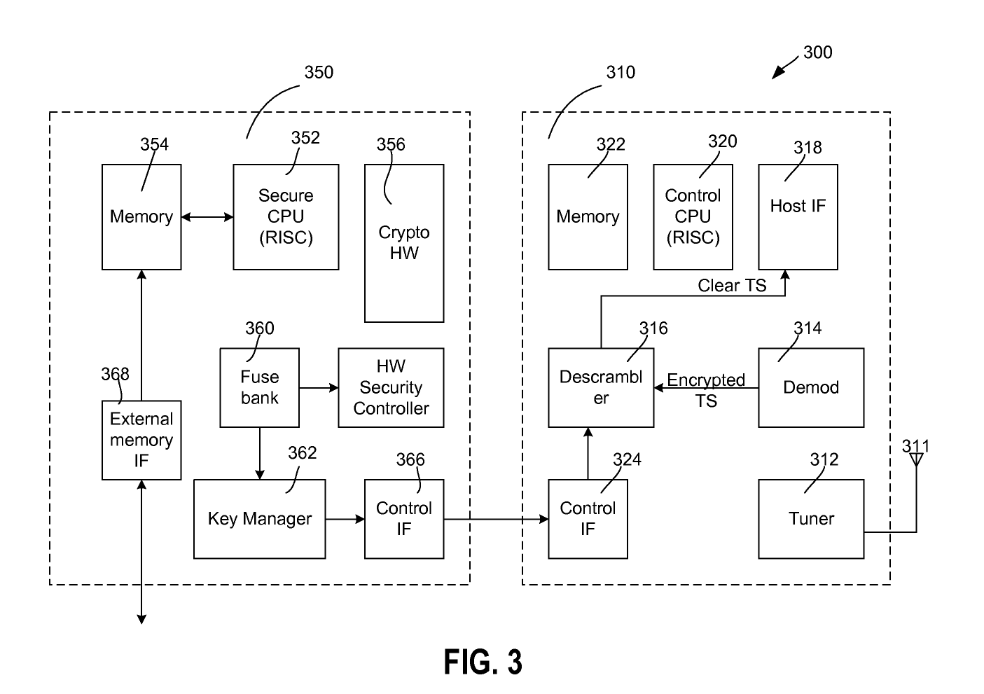

FIG. 3 is a simplified block diagram of a receiver system on a chip (SOC) 300 configured to perform tuning, demodulating, CA security, and the like, in accordance with an embodiment of the present invention. Receiver system 300 includes a digital broadcast receiver 310 that may be capable of receiving signals in a number of different frequency bands of interest and/or in a number of different formats. By way of example, receiver system 300 may be capable of receiving any one or more of the standards mentioned above or other suitable standards. In an exemplary embodiment, receiver system 300 also includes a conditional access security (CAS) sub-system 350.

Digital broadcast receiver 310 includes a tuner 312 that is connected to an antenna 311. Although an antenna is shown, tuner 312 may be connected to a number of antennas. The tuner is configured to frequency translate received signals and provide them to a demodulator 314 which demodulate the frequency translated signals into multiple data streams (audio, video, text, and others). Receiver 310 also includes a descrambler 316 that descrambles the data streams (indicated as encrypted TS) and provides clear (i.e., descrambled) data streams (indicated as clear TS in FIG. 3) to a host via a host interface unit 318. Receiver 310 further includes a control processor 320 and a memory unit 322 that contains software (program code) to enable a user to select a service and to program the tuner to a desired frequency. In an embodiment, the memory 322 may include dynamic random memory and/or permanent memory such as read-only memory (ROM).

Receiver 310 also includes a control interface unit 324 that connects the digital broadcast receiver 310 with the conditional access security sub-system 350. As described in section above, control access is a protection of content required by content owners or service providers. Conventional access approaches use dedicated surface mount device such as Smartcard, SIM card, secure SD card or the like. In conventional approaches, CA instruction code and keys provisioned by CA providers adapted to ensure security are typically stored in a non-volatile memory, such as an EEPROM or Flash, which are relatively expensive and cannot be easily and cost effectively integrated using standard CMOS fabrication processes. A novel conditional access security (CAS) sub-system according to an embodiment of the present invention will be described in detail below.

Referring to FIG. 3, CAS sub-system 350 includes a secure processor 352 coupled to a memory unit 354. The secure CPU may be a RISC CPU configured to process various processing operations. CAS sub-system 350 further includes a crypto hardware 356 that, in an embodiment, includes suitable crypto logic, circuitry (e.g., hardware) for performing cryptographic operations. In a specific embodiment, crypto hardware 356 may be a crypto processor configure to perform cryptographic functions such as processing digital signature, key management, identifying public keys and others due to the secure access requirements. During the manufacturing process, cryptographic hardware may generate a unique crypto ID (identity) for the receiver SOC 300 and a unique encryption key. CAS sub-system also includes a fuse bank 360. In an embodiment, fuse bank 360 may include electrically programmable fuses on the chip. In an embodiment, the fuse bank may contain an array of electrically programmable registers, each having a number of bits. The bits can be programmed during the manufacturing process or later by the service provider as the device is shipped to the user. In an embodiment, corresponding bits of the fuse bank are burned or blown according to the value of the unique device ID and a certificate key. In a specific embodiment, memory unit 354 includes random access memory and read-only memory. In contrast to conventional techniques, memory unit 354 does not includes EEPROM and/or Flash memory to facilitate the integration process and to minimize cost by using conventional (i.e., standard) CMOS process.

In an embodiment, the receiver SOC 300 includes an external memory interface 368 configured to interface with an external memory. Although the external memory interface 368 is shown to be located in the CAS sub-system 350, it can be located in any part of the receiver SOC as further disclosed below. In an embodiment, the external memory interface 368 can include a SD memory card slot, a multimedia card (MMC), a micro SD card slot, a mini SDHC, a microSDHC, a Memory Stick slot, a PCMCIA interface, and others. The external memory can be a commercial off-the-shelf Flash memory. In accordance with embodiments of the present invention, the conditional access (CA) software code is stored in a random access memory (RAM). The CA software is dynamically downloaded from an external non-volatile flash memory via the external memory interface 368 to the RAM during the power cycle of the security sub-system. However, because the external flash storing the CA software is outside the security perimeter it must first be authenticated and checked for any malicious alteration (such as bypass of the security function that could be inserted by a hacker). The secure sub-system implements a protocol to authenticate the firmware using a public key algorithm and digital certificate provisioned during manufacturing.

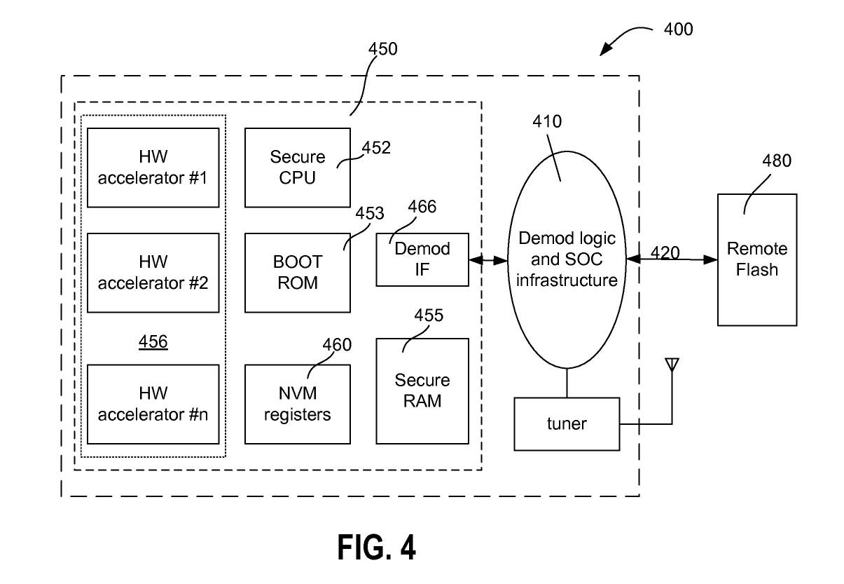

FIG. 4 is a block diagram of a demodulator SOC 400 including a tuner coupled to an antenna, a demodulation logic 410 coupled to the tuner, and an integrated secure element 450 according to an embodiment of the present invention. Demodulation logic 410 may have a similar configuration of the receiver 310 shown in FIG. 3. For example, demodulation logic 410 may include a demodulator, a descrambler, a control CPU, a memory unit that comprises RAM and/or ROM, a host interface, and a control interface unit; the functions of those elements have been described in details in the sections above and won't be repeated herein for brevity. The demodulator logic 410 further includes system-on-a chip infrastructure such as registers, IO ports, an external memory interface port 420, which may be similar to the external memory interface port 368 shown in FIG. 3 and described above. In an embodiment, a remote or external Flash memory 480 may be coupled to the demodulator SOC 400 through the demodulator logic 410. In another embodiment, the remote Flash memory may be coupled to the demodulator SOC 400 through a memory port disposed in the integrated secure element 450 (not shown).

In an embodiment, integrated secure element 450 includes a secure CPU 452, a boot read-only memory (ROM) 453, a secure random access memory (RAM) 455, a plurality of non-volatile memory registers 460. In an embodiment, the non-volatile memory registers are implemented using fuse cells that can be fabricated using standard CMOS processes. In an embodiment, the non-volatile memory registers are programmed (burned or blown) during the silicon manufacturing process to store information such as the device ID, the root public key, and others. Integrated secure element 450 also includes multiple hardware accelerators 456 that can be one or more crypto processors as described above in association with crypto hardware 356 of FIG. 3.

In order to minimize cost, the CA software code is stored in the secure RAM 455 according to an embodiment of the present invention. CA software is understood as instructions or one or more sets of instructions that are provided to the secure CPU 452 for execution. CA software is dynamically downloaded from the remote (external) flash memory 480 to the RAM 455 (“RAM-ware”) during the power cycle of the integrated secure element 450. Because CA software is downloaded from the external Flash memory, it must be first authenticated by the integrated secure element 450. In an embodiment, the secure element operates a protocol to authenticate the RAM-ware using a public key algorithm and a digital certificate that is provided during the manufacturing of the demodulator SOC. In an embodiment, the authentication process can be assisted and accelerated using the hardware accelerators 456.

In an embodiment, CA software is received by the demodulator logic from the external memory and transferred to the secure RAM 455 via a demodulator interface circuit 466. In contrast to conventional secure elements that store the CA software code in EEPROM and/or Flash memory, embodiments of the present invention provides a RAM-ware architecture that can be updated easily and securely (e.g., by reading in software codes stored in external memories). Because the RAM-ware architecture does not require EEPROM and/or Flash memory, it can be cost effectively produced using standard CMOS processes.

In an embodiment, the integrated secure element produces an attribute based on a digital certificate contained in the received software (now RAM-ware because it is now stored in the secure RAM) and provides the attribute to the demodulator logic for descrambling the received data streams (not shown). In some embodiments, the attribute can be a secure bit pattern or a secure codeword to enable the descrambling process in the demodulator logic 410.

In an embodiment, the integrated secure element 450 is activated when the TV application is enabled by the user. When the TV application is enabled, the demodulator logic causes the boot ROM to execute the boot instructions and activate the integrated secure element. During the boot process, the conditional access (CA) firmware stored in the external flash memory is downloaded to the RAM disposed in the secure element, so that the CPU starts operating.

As described above, the remote Flash memory contains conditional access (CA) software or code that is dynamically loaded to the RAM 455 disposed in the integrated secure element. In an embodiment, the external memory contains a digital certificate that is generated by the CA vendor or the demodulator SOC device manufacturer and signed with the root private key or a derivative of the root key using public key infrastructure (PKI). In an embodiment, the digital certificate may be unique to each demodulator SOC device and contains a device identification (ID) code. In an embodiment, the same identification code is also stored in one or more of the non-volatile registers 460. In an embodiment, the non-volatile registers 460 may also store a digital signature of the CA software or CA firmware. In an embodiment, the boot ROM authenticates the firmware using the digital certificate.

In an embodiment, the secure boot ROM may process the digital certificate as follows: (i) verify that the certificate is authentic and the certificate has been signed by a trusted delegate of the root key owner; (ii) verify that the certificate is intended for the given device by comparing the device ID stored in the secure element NVM (non-volatile memory) registers and the code stored in the certificate to ensure that they match; and (iii) authenticate the firmware by regenerating its signature with the root public key and comparing the result with the value stored in the certificate. Only when the above three steps are successful, the SW that has been downloaded to the secure element RAM is verified and considered to be trustworthy. In an embodiment, the SW code in the external memory may be encrypted. In this case, it is first deciphered by the boot ROM. The SW encryption key (or a derivative) is stored in the secure element NVM registers and used directly by the ROM code.

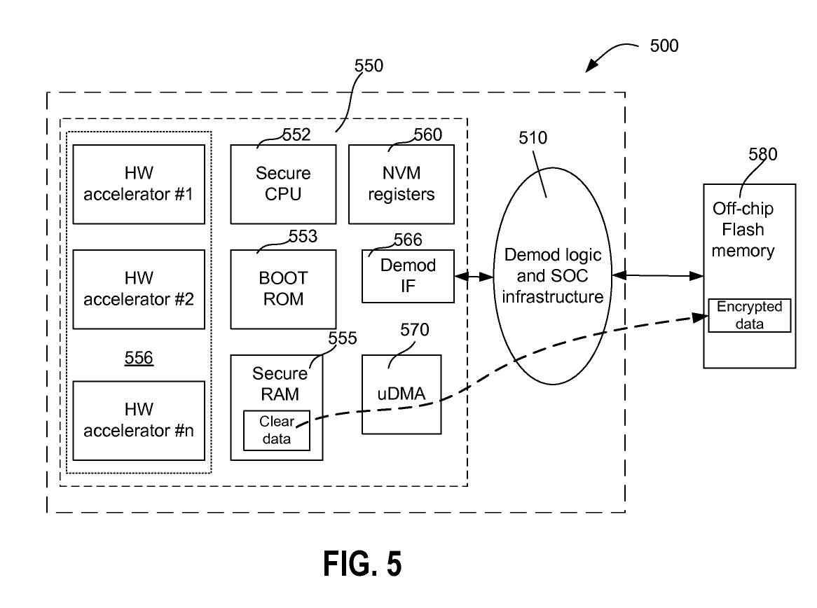

FIG. 5 is a simplified block diagram of an integrated secure element disposed in a demodulator SOC 500 according to an embodiment of the present invention. Demodulator SOC 500 includes a demodulation logic 510 that may have a similar configuration of the receiver 310 shown in FIG. 3. For example, demodulation logic 510 may include a demodulator, a descrambler, a control CPU, a memory unit that comprises RAM and/or ROM, a host interface, and a control interface unit; the functions of those elements have been described in details in the sections above and won't be repeated herein for brevity reason. The demodulator logic 510 may further include system-on-a chip infrastructure such as registers, IO ports, one or more direct memory access controllers for interfacing with external storage devices, and other hardware and firmware. In an embodiment, a remote or external Flash memory 580 may be coupled to the demodulator SOC 500 through the demodulator logic 510 via a direct memory access controller (DMA).

Demodulator SOC 500 also includes an integrated secure element 550 that is coupled to the demodulation logic 510. In an embodiment, integrated secure element 550 includes a secure CPU 552, a boot read-only memory (ROM) 553 containing a boot code that causes the secure CPU to fetch instruction codes or data disposed in the external memory 580 and stores the instruction codes or data in a secure random access memory (RAM) 555. Integrated secure element 550 also includes a plurality of non-volatile memory registers 560 that are implemented using fuse cells that can be fabricated using standard CMOS processes, i.e., without the additional processing steps required for making EEPROM or Flash memory units of conventional secure elements. For example, the non-volatile memory registers are programmed (burned or blown) during the silicon manufacturing process to store information such as the device ID, the root public key, and others. Integrated secure element 550 further includes multiple hardware accelerators 556 that can be one or more crypto processors as described above in association with crypto hardware 356 of FIG. 3.

In accordance with some embodiments of the present invention, CA software, i.e., one or more sets of instructions provided to the secure CPU for execution, is stored in the secure

RAM 555 to reduce hardware implementation cost. The CA software is dynamically downloaded from the remote (external) flash memory 580 to the RAM 555 (“RAM-ware”) during the power cycle of the integrated secure element 550. Because the CA software is downloaded from the external Flash memory, it must be first authenticated by the integrated secure element 550. In an embodiment, the secure element operates a protocol to authenticate the RAM-ware using a public key algorithm and a digital certificate that is provided during the manufacturing of the demodulator SOC. In an embodiment, the authentication process can be assisted and accelerated using the hardware accelerators 556.

In an embodiment, CA software is received by the demodulator logic from the external memory and transferred to the secure RAM 555 via a demodulator interface circuit 566. In contrast to conventional secure elements that store the CA software code in on-chip EEPROM and/or Flash memory, embodiments of the present invention provides a RAM-ware architecture that can be updated easily and securely (e.g., by reading in software codes stored in external memories). Because the RAM-ware architecture does not require EEPROM and/or Flash memory, it can be cost effectively produced using standard CMOS processes.

In an embodiment, the integrated secure element produces an attribute based on a digital certificate contained in the received software (now RAM-ware because it is now stored in the secure RAM) and provides the attribute to the demodulator logic for descrambling the received data streams (not shown). In some embodiments, the attribute can be a secure bit pattern or a secure codeword to enable the descrambling process in the demodulator logic 510.

In an embodiment, the integrated secure element 550 is activated when a TV application is enabled by the user. When the TV application is enabled, the demodulator logic 510 causes the boot ROM to execute the boot instructions and activate the integrated secure element. During the boot process, the conditional access (CA) firmware stored in the external flash memory is downloaded to the secure RAM disposed in the secure element 550, so that the secure CPU 552 starts operating.

As described above, the remote Flash memory contains conditional access (CA) software or code that is dynamically loaded to the RAM 555 disposed in the integrated secure element. In an embodiment, the external memory contains a digital certificate that is generated by the CA vendor or the demodulator SOC device manufacturer and signed with the root private key or a derivative of the root key using public key infrastructure (PKI). In an embodiment, the digital certificate may be unique to each demodulator SOC device and contains a device identification (ID) code. In an embodiment, the same identification code is also stored in one or more of the non-volatile memory registers 560. In an embodiment, the non-volatile memory registers 560 may also store a digital signature of the CA software or CA firmware. In an embodiment, the boot ROM authenticates the firmware using the digital certificate.

In an embodiment, the secure boot ROM may process the digital certificate as follows: (i) verify that the certificate is authentic and the certificate has been signed by a trusted delegate of the root key owner; (ii) verify that the certificate is intended for the given device by comparing the device ID stored in the secure element NVM (non-volatile memory) registers and the code stored in the certificate to ensure that they match; and (iii) authenticate the firmware by regenerating its signature with the root public key and comparing the result with the value stored in the certificate. Only when the above three steps are successful, the SW that has been downloaded to the secure element RAM is verified and considered to be trustworthy. In an embodiment, the SW code in the external memory may be encrypted for confidentiality. In this case, it is first deciphered by the boot ROM. The SW encryption key (or a derivative) is stored in the secure element NVM registers and used directly by the ROM code.

In accordance with some embodiments of the present invention, as shown in FIG. 5, external flash memory 580 is used to back up (copy) the data stored in the secure RAM during the execution of the CA SW. The backup operation may be triggered in response to any number of events, such as (i) when recurring timers force a periodic backup; (ii) when a specific data set is modified, based, for example, on the secure firmware state-machine and key provisioning; or (iii) upon a power-off cycle when an off condition is detected or requested by the host. In other embodiments, the backup operation can be dynamically user driven or based on other criteria.

Referring to FIG. 5, integrated secure element 550 includes a direct memory access (DMA) controller 570 coupled to secure RAM 555. DMA controller 570 is a hardware feature that enables movement of blocks of data from peripheral to memory, memory to peripheral, or memory to memory with minimal involving of the secure CPU. In an embodiment, the DMA controller can also be used to move data in parallel with the CPU. In some embodiments, the DMA controller retrieves the clear data stored in the secure RAM and writes it to an external memory port that can reside in the integrated secure element (shown as external memory interface 368 in FIG. 3 or memory port interface 420 in FIG. 4). The DMA controller manages the flow of data in and out of the secure element 550. In some embodiments, the DMA controller operations can be performed by secure CPU 552.

In an embodiment, the clear data stored in the secure RAM is encrypted using an encryption key before being backing up. The encryption key can be from a private key security system, where the integrated secure element 550 and the external memory 580 share a “private” key for encrypting and decrypting data passing between them. In an embodiment, the encryption key can be from a public key system, where the secure element has a key pair that consists of a private key and a public key, wherein both keys are used to encrypt and decrypt data, and the private key is only known to the integrated secure element, and the public key is available to many other devices.

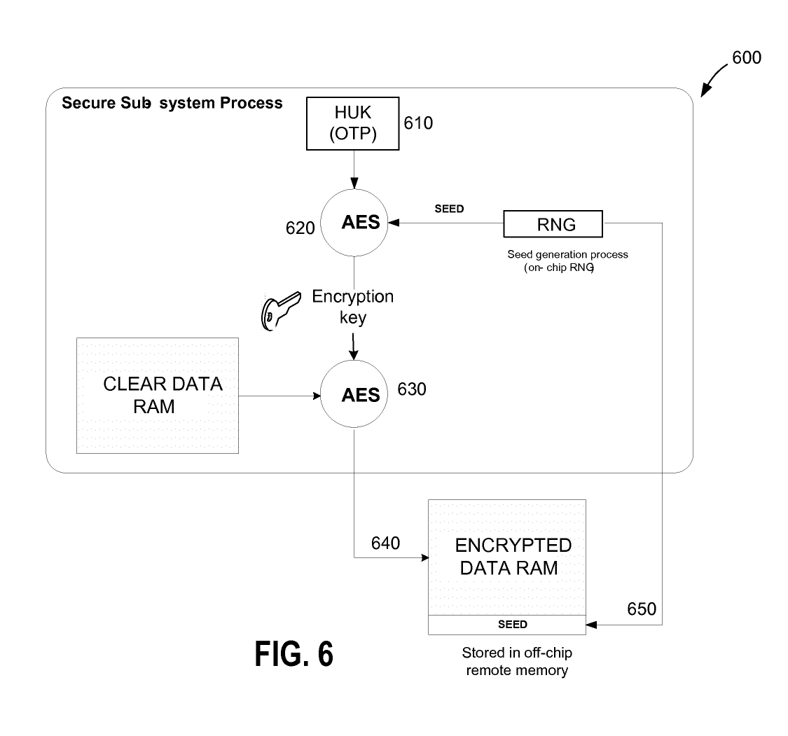

FIG. 6 is an exemplary process 600 for generating an encryption key and for outputting encrypted data to an external memory according to an embodiment of the present invention. At step 610, a hardware unique key (HUK) that is stored in one of the non-volatile memory registers is provided to an AES circuit. The AES circuit can be one of the HW accelerators 556 performing known encryption algorithms, such as DES/3DES, RSA and/or SHA hashing algorithms. At step 620, the AES circuit processes the HW unique key with a seed, which can be a random number. The seed number, i.e., the random number, can be generated from an on-chip random number generator (e.g., one of the HW accelerators) in an embodiment of the present invention. An encryption key is then generated and provided to a second AES circuit. The second AES processes the clear data stored in the secure RAM with the encryption key at step 630 according to an encryption algorithm and produces encrypted data. In an embodiment, the first AES and second AES circuits can be the same AES circuit. In another embodiment, they may be individual circuits. At step 640, the encrypted data is written to the external memory. In an embodiment, the seed number is also written to the external memory at a predetermined location (step 650).

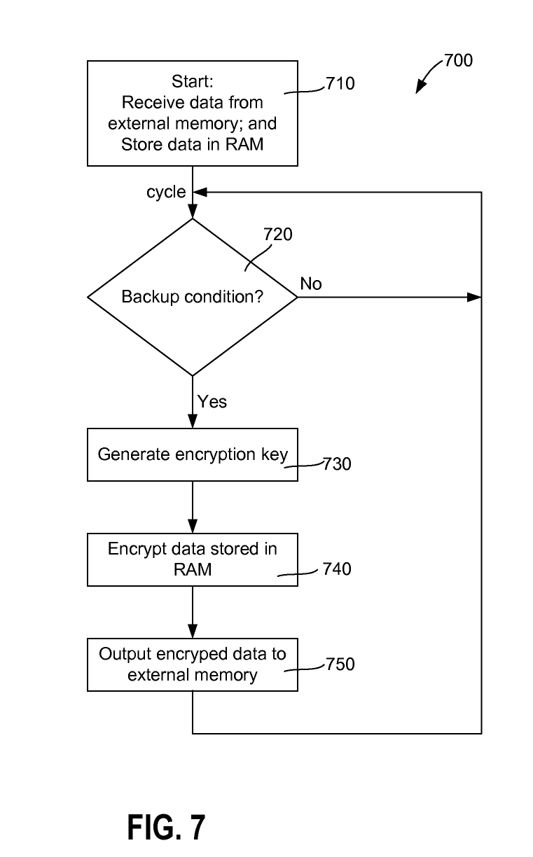

FIG. 7 is a flowchart diagram 700 illustrating a data backup method according to an embodiment of the present invention. The flowchart is described together with the features shown in FIG. 5. At step 710, when the demodulator is enabled, the demodulator logic causes the boot ROM to execute boot instructions and activate the integrated secure element 550. During the start up process, data (i.e., software code or executable program code) stored in the external memory 580 is written to the secure RAM disposed in the secure element, so that the secure CPU 552 starts executing. In an embodiment, the boot ROM disposed in the integrated secure element authenticates the downloaded data (executable program code) by comparing a digital certificate embedded in the downloaded data with the device ID stored in the secure element non-volatile registers. At step 720, the secure element 550 determines whether a backup condition occurs. Backup conditions may occur dynamically under user input, on timed intervals, upon the detection of a power-off event, and/or others. In the event that a backup condition is determined, the secure element generates an encryption key at step 730. In an embodiment, the encryption key is generated according to the logic steps described in association with FIG. 6. The integrated secure element then encrypts data stored in the secure RAM at step 740 and writes the encrypted data to an external memory at step 750. In an embodiment, the process of writing the encrypted data to the external memory can be performed using a direct memory (DMA) controller or a micro DMA (uDMA) controller. In some embodiments, the DMA or uDMA operations can be performed by the secure CPU. At step 720, if there is no backup condition, the process returns back to step cycle.

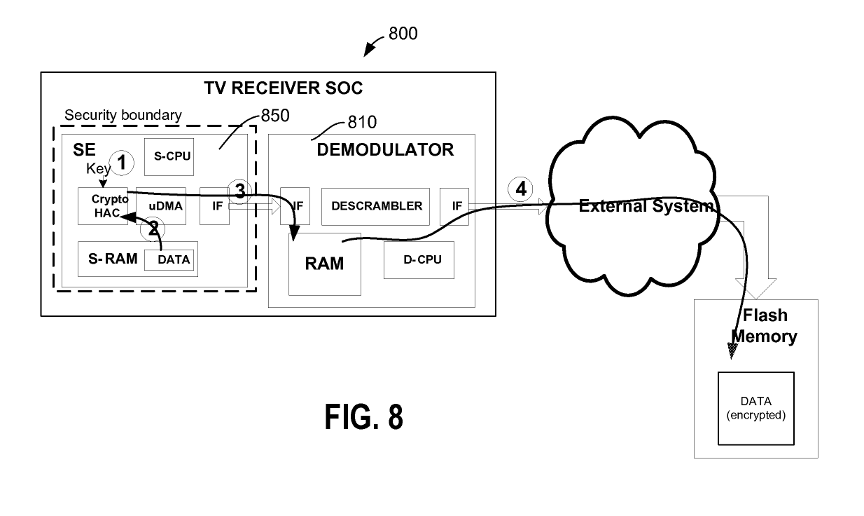

FIG. 8 is a simplified block diagram of a demodulator SOC 800 (e.g., a TV receiver SOC) illustrating an exemplary data backup operation according to an embodiment of the present invention. Demodulator SOC 800 includes a demodulator 810 and an integrated secure element 850. Upon detecting a backup condition, the integrated secure element generates a data encryption key (indicated as “key” next to step 1 in FIG. 8) from a HW unique key HUK and a seed number, which is a random number generated by one of the HW accelerators. At step 2, the DMA or micro DMA controller reads data stored in the secure RAM and provides the data to a crypto processor (i.e., one of the HW accelerators), which encrypts the data using the generated data encryption key. In an embodiment, a data buffer hash value is also generated and encrypted. The hash value may be used as a checksum during the data retrieval process. At step 3, the DMA controller pushes the encrypted data to the demodulator sub-system RAM through the demodulator interface. At step 4, the demodulator writes the encrypted data to an external memory.

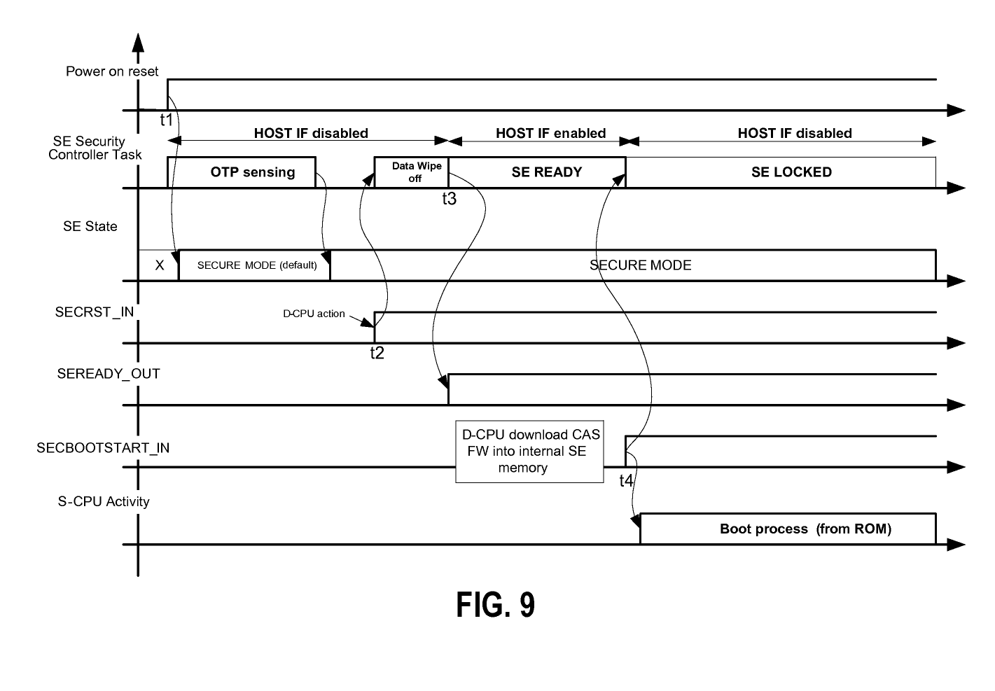

FIG. 8 describes a data backup operation upon shutting down the demodulator SOC. A data writing operation from an external memory to the demodulator SOC at run time is now described. FIG. 9 is a simplified timing diagram illustrating a startup operation of a demodulator SOC according to an embodiment of the present invention. Upon completion of a power-on-reset at time t1, the secure element is in the default secure mode, and the host interface is disabled. The secure CPU updates the working registers with values stored in the corresponding non-volatile memory registers. At time t2, the demodulator CPU instructs the secure CPU to wipe clean the secure RAM. At time t3, upon the secure memory is wiped clean, the secure element signals to the demodulator that the secure memory is ready for data download, the host interface is enabled, and the download process starts. Upon the download completion, the secure CPU can start the boot-up process at time t4, the secure element is now locked and the host interface is disabled. This diagram is merely an example, which should not unduly limit the scope of the claims. One of ordinary skill in the art would recognize many variations, alternatives, and modifications.

The invention is not limited to a specific type of digital broadcast signals as the multiple hardware accelerators can assist CPU to process a specific type of digital signal. The CPU may include suitable logic, circuitry and program code for performing conditional access operations, detection of backup conditions, and others. In an embodiment, the CPU may be configured to process a specific conditional access to a service provider. The random access memory may store new conditional access operations that are either specific to a service provider or content owner. In an embodiment, the boot ROM may load and store code and data to perform conditional access operations. In an embodiment, the non-volatile memory registers include one or more fuse banks or fuse registers to store information for authentication and device specific identification (ID). In another embodiment, the hardware accelerators may include one or more AES circuits to generate an encryption key and/or perform data encryption.

Many alternatives, modifications, and variations will be apparent to those skilled in the art in light of the above teachings. For example, although embodiments of the present invention are described in relation to a handheld receiver device for digital TV, they can also be applied to portable receivers such as laptop computers, notebooks, tablets and other mobile devices such as car receivers for receiving digital audio broadcastings or other controlled broadcasting standards. Embodiments of the present invention can also apply to networked devices.

It is understood that the above embodiments of the present invention are illustrative and not limitative. Various alternatives and equivalents are possible. The invention is not limited by the type of integrated circuits in which the present disclosure may be disposed. Other additions, subtractions or modifications are obvious in view of the present invention and are intended to fall within the scope of the appended claims.

What is claimed is:

1. An integrated circuit comprising:
a demodulator for receiving an encrypted content; and
a hardware unit communicatively coupled to the demodulator, the hardware unit comprising:
a processing unit;
a read-only access memory comprising a boot code adapted to cause the integrated circuit to fetch data from an external memory;
a random access memory adapted to store the fetched data and provide the stored data to the processing unit for execution;
a plurality of non-volatile memory registers or fuses; and
an interface unit adapted to provide the data stored in the random access memory to an external storage in response to a backup event.

2. The integrated circuit of claim 1, wherein the external storage comprises a flash memory.

3. The integrated circuit of claim 1, wherein the interface unit comprises a direct memory access controller circuit.

4. The integrated circuit of claim 1, wherein the hardware unit enables the demodulator to decrypt the encrypted content.

5. The integrated circuit of claim 1, wherein the provided data to the external storage are encrypted using an encryption key generated in accordance with an encryption algorithm.

6. The integrated circuit of claim 5, wherein the encryption key is generated using a unique code of the integrated circuit and a seed number.

7. The integrated circuit of claim 6, wherein the unique code is stored in one of the plurality of non-volatile registers or fuses.

8. The integrated circuit of claim 6, wherein the seed number is a random number.

9. The integrated circuit of claim 5, wherein the encryption key is dynamically generated.

10. The integrated circuit of claim 1, wherein the backup event occurs in timed intervals.

11. The integrated circuit of claim 1, wherein the backup event is triggered by a power-off condition.

12. The integrated circuit of claim 1, wherein the backup event is triggered when a modification in a content of the random access memory is detected.

13. A data processing device having a random access memory (RAM) based security element coupled to a demodulator adapted to receive encrypted information, the data processing device performing a method comprising:
receiving data from a first external memory, the data being adapted to enable the demodulator to decrypt the encrypted information;
storing the received data in the random access memory disposed in the security element;
determining whether the device has a backup condition and, in the event that the device has a backup condition,
encrypting the data stored in the random access memory; and
outputting the encrypted data to a second external memory.

14. The method of claim 13 further comprising authenticated the data stored in the random access memory.

15. The method of claim 13, wherein the encrypting comprises an encryption key generated in accordance with an encryption algorithm.

16. The method of claim 15, wherein the encryption key is generated using a unique code and a seed number, the unique code being stored in a non-volatile memory register disposed in the security element and the seed number being generated by a random number generator disposed in the security element.

17. The method of claim 15, wherein the encryption key is dynamically generated.

18. The method of claim 13, wherein the backup condition is triggered by a power down event.

19. The method of claim 13, wherein the first external memory and the second external memory are a same flash memory.

20. The method of claim 13, wherein the act of outputting comprises the use of a direct memory access controller.

21. A device having a random access memory (RAM) based security element storing a computer program to process digital television signals, the computer program causing the device to perform steps comprising:
encrypting the computer program stored in the random access memory disposed in the security element; and
writing the encrypted computer program to an external memory in response to a backup event.

22. The device of claim 21, wherein the backup event is user driven or triggered by a power-off condition.
